(19) United States
(12) Patent Application Publication
(10) Pub. No.: US 2007/0221085 A1
(43) Pub. Date: Sep. 27, 2007

(54) PRINTER, METHOD, COMPUTER-READABLE MEDIUM, AND COMPUTER DATA SIGNAL

(75) Inventor: Takashi Hashizume, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/566,786

(22) Filed: Dec. 5, 2006

(30) Foreign Application Priority Data
Mar. 27, 2006 (JP) 2006-084727

(51) Int. Cl. B41F 33/00

(52) U.S. Cl. 101/483

(57) ABSTRACT

A printer includes a print request acceptance unit that accepts a print request that includes an instruction book in which print instructions are described; an instruction book determination unit that determines if the print instructions described in the accepted instruction book can be executed on the printer; an instruction book correction unit that, when it is determined that the print instructions described in the instruction book cannot be executed, corrects the instruction book and generates an instruction book in which print instructions executable by the printer are described; and an instruction book output unit that outputs the generated instruction book.

### PRIORITY INFORMATION

This application claims priority to Japanese Patent Application No. 2006-84727, filed on Mar. 27, 2006.

### BACKGROUND

1. Technical Field

The present invention relates to a printer, a method, a computer-readable medium, and a computer data signal.

2. Related Art

There is a printer that accepts a print request, which includes an instruction book (also called a job ticket) in which print instructions are described, and prints data in accordance with the contents described in the instruction book.

In such a printer, the hardware configuration of the printer is sometimes incompatible with the contents of the instruction book. For example, a printer without a double-sided printing unit sometimes receives an instruction book in which a double-sided printing instruction is described.

In such a case, a conventional printer either generates an error and stops the processing, or replaces a failed-operation with a default value and continues the print processing.

### SUMMARY

According to one aspect of the present invention, there is provided a printer having: a print request acceptance unit that accepts a print request that includes an instruction book in which print instructions are described; an instruction book determination unit that determines if the print instructions described in the accepted instruction book can be executed on the printer; an instruction book correction unit that, when it is determined that the print instructions described in the instruction book cannot be executed, corrects the instruction book and generates an instruction book in which print instructions executable by the printer are described; and an instruction book output unit that outputs the generated instruction book.

### BRIEF DESCRIPTION OF THE DRAWINGS

Exemplary embodiments of the present invention will be described in detail based on the following figures, wherein:

FIG. 1 is a block diagram showing the configuration of a system including a printer in this exemplary embodiment; and

FIG. 2 is a flowchart showing an operation procedure of the printer in this exemplary embodiment.

### DETAILED DESCRIPTION

Exemplary embodiments of the present invention will be described below with reference to the drawings.

### First Exemplary Embodiment

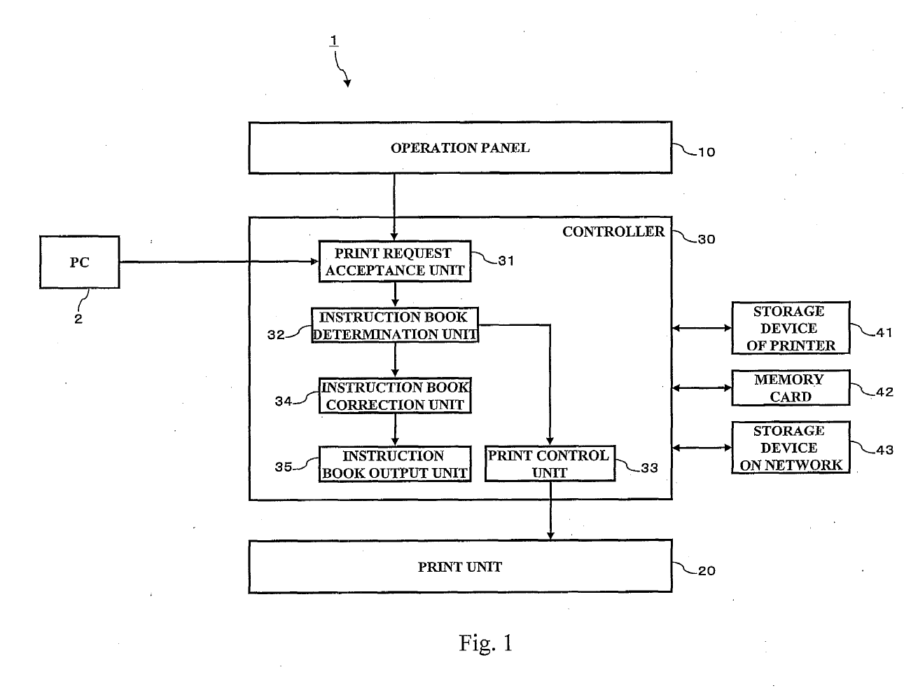

FIG. 1 is a block diagram showing the configuration of a system that includes a printer 1 in this exemplary embodiment. The printer 1, which is a device for printing data in response to a print request, is an MFP (Multi Function Peripheral) in this exemplary embodiment that has a printer function, a scanner function, and a copy function. As shown in FIG. 1, the printer 1 includes an operation panel 10, a print unit 20, and a controller 30.

The operation panel 10 is, for example, a touch-panel display, and is a user interface that presents various types of information to the user and accepts an operation input from the user.

The print unit 20 is a device that prints images on a print medium, such as paper, by means of an appropriate print method such as the xerography method or the inkjet method.

The controller 30 controls the printer 1 in its entirety. In this exemplary embodiment, the controller 30 is a circuit board on which a CPU (Central Processing Unit), ROM (Read Only Memory), a memory, and NVRAM (Non Volatile RAM) are installed. The function of the controller 30 is implemented by the CPU that executes a program read from a recording medium such as the ROM. The controller 30 includes the following functional blocks: a print request acceptance unit 31, an instruction book determination unit 32, a print control unit 33, an instruction book correction unit 34, and an instruction book output unit 35.

The print request acceptance unit 31 accepts a print request that includes an instruction book in which print instructions are described. In this case, the instruction book is an electronic file in which print settings are described in a predetermined description format such as XML (Extensible Markup Language) Examples of well-known print settings include double-sided printing, N-up printing, stapling, punching, color printing, and sorting/stacking. A print request that includes an instruction book may include the instruction book itself, or may include an identifier or address that specifies the instruction book. The instruction book may be used by one device type or shared by multiple device types.

In this exemplary embodiment, the print request acceptance unit 31 accepts a print request, which includes an instruction book, either from a client PC 2 connected via a network or through a user operation performed on the operation panel 10. For example, the print request acceptance unit 31 receives from the client PC 2 a print request, which includes an electronic document to be printed and an instruction book. Alternatively, the print request acceptance unit 31 accepts a print request, which specifies an electronic document and an instruction book, from the PC 2 or the operation panel 10 and reads the specified electronic document and the instruction book from an appropriate storage device. The appropriate storage devices are a storage device 41 of the printer, a memory card 42, which is a portable storage device, and a storage device 43 on the network.

The instruction book determination unit 32 determines if the print instructions described in an instruction book, accepted by the print request acceptance unit 31, can be executed on the printer. More specifically, the instruction book determination unit 32 references the hardware configuration information on the printer 1 to determine if the hardware configuration of the printer 1 is compatible with the contents of the instruction book.

When the instruction book determination unit 32 determines that the print instructions described in the instruction book can be executed, the print control unit 33 causes the print unit 20 to print data in accordance with the print request accepted by the print request acceptance unit 31. More specifically, the print control unit 33 works with the print unit 20 to print the electronic document, specified by the print request, in accordance with the print settings described in the instruction book included in the print request.

When the instruction book determination unit 32 determines that the print instructions described in the instruction book cannot be executed, the instruction book correction unit 34 corrects the instruction book and generates an instruction book in which the print instructions executable by the printer 1 are described. More specifically, when the hardware configuration is incompatible with the instruction book, the instruction book correction unit 34 corrects the instruction book by reference to the hardware configuration information and generates a new instruction book that contains the incompatibility-corrected print instructions.

The instruction book output unit 35 outputs the instruction book generated by the instruction book correction unit 34. In this exemplary embodiment, the instruction book output unit 35 sends the generated instruction book to a specified destination. This specified destination may be predetermined, or may be specified when the print request is issued. In this exemplary embodiment, the instruction book output unit 35 sends an e-mail, which includes the new instruction book and the contents of incompatibility (or correction), to a mail address specified upon issuance of the print request. The mail address is described, for example, in the instruction book.

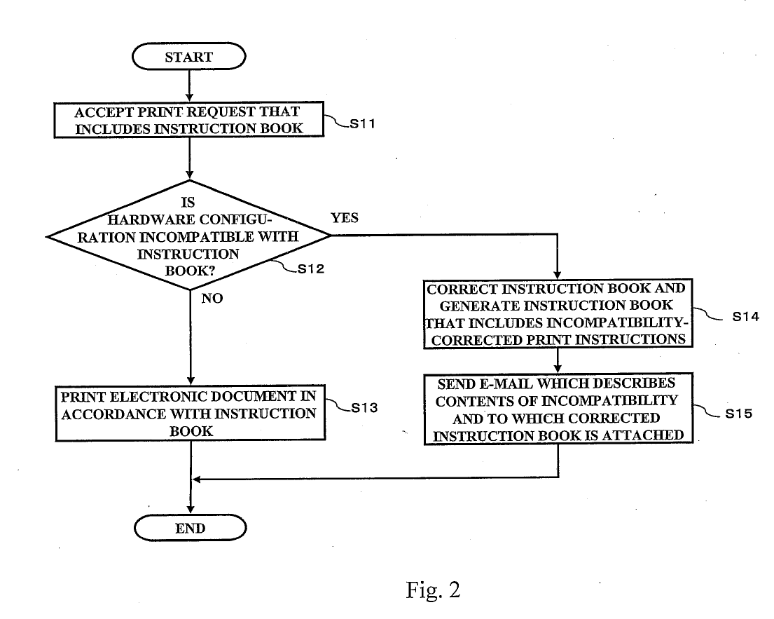

FIG. 2 is a flowchart showing the operation procedure of the printer 1 in this exemplary embodiment. With reference to FIG. 2, the following describes in detail the operation of the printer 1 that has the configuration described above.

In accordance with user operation, the client PC 2 sends a print request, which includes an electronic document to be printed and an instruction book, to the printer 1 via the network.

The print request acceptance unit 31 of the printer 1 receives the print request from the PC 2 and passes the received print request to the instruction book determination unit 32 (S11).

In response to the print request from the print request acceptance unit 31, the instruction book determination unit 32 references the hardware configuration information on the printer land determines if an incompatibility exists between the hardware configuration of the printer 1 and the contents of the instruction book (S12).

If it is determined that no incompatibility exists (S12: NO), the instruction book determination unit 32 passes the print request to the print control unit 33. Upon receiving the print request, the print control unit 33 controls the print unit 20 to print the electronic document, included in the print request, in accordance with the print settings described in the instruction book included in the print request (S13). For example, if the instruction book describes that “the front colored cover sheet is applied, the document is punched on the left side, and the document is stapled in the upper-left corner,” the print unit 20 applies the front colored cover sheet, punches the document on the left, and staples the document in the upper-left corner in accordance with the control instruction from the print control unit.

On the other hand, if it is determined that an incompatibility exists (S12: YES), the instruction book determination unit 32 passes the print request to the instruction book correction unit 34. Then, the instruction book correction unit 34 corrects the instruction book included in the print request by reference to the hardware configuration information and generates a new instruction book that includes incompatibility-corrected print instructions (S14). For example, if an instruction book describing “the front colored cover sheet is applied, the document is double-sided printed with the long edge bound, the document is punched on the left side, and the document is stapled in the upper-left corner” is sent to the printer 1 that does not have a double-sided printing unit, the instruction book correction unit 34 deletes the specification of double-sided printing and generates an instruction book describing “the front colored cover sheet is applied, the document is punched on the left side, and the document is stapled in the upper-left corner.” The instruction book correction unit 34 notifies the instruction book output unit 35 of the generated instruction book and the contents of the incompatibility.

In response to the notification, the instruction book output unit 35 sends an e-mail, whose mail text describes the contents of the notified incompatibility and to which the notified instruction book is attached, to the mail address specified in the instruction book (S15). For example, if an instruction book describing double-sided printing is sent to the printer 1 that does not have a double-sided printing unit, the instruction book output unit 35 includes the description “the printer has not a double-sided printing unit” in the mail text and sends the mail to the mail address specified in the instruction book, while attaching the instruction book, from which the double-sided printing description is deleted, as an attached file.

Note that, the printer 1 described above may receive a copy request as a print request that includes an instruction book. More specifically, the printer 1 may accept a copy instruction, as well as the specification of an instruction book, from the user via the operation panel 10. In this case, the printer 1 reads the image of a document that is set on the printer 1 to generate the image data and prints the image data in accordance with the print settings described in the specified instruction book.

Although in the above description the corrected instruction book is mailed, the instruction book output unit 35 may save the corrected instruction book in a specified storage location. In this case, the instruction book output unit 35 may notify the user, who issued the request, by mail that the corrected instruction book is saved in a storage location and, in addition, may notify the user of the contents of the incompatibility (or correction) The specified storage location may be predetermined, or may be specified when the print request is issued. The predetermined storage locations are, for example, the storage device 41 of the printer, the memory card 42, or the storage device 43 on the network.

Although in the above description the printer does not print data if an incompatibility is found in the instruction book, the printer may also print data in accordance with the corrected instruction book.

If an incompatibility is found in the instruction book, it is also possible for the printer 1 to correct the instruction book, generate multiple instruction books, and output (mail, save, etc.) the multiple instruction books that are generated.

### Second Exemplary Embodiment

A printer in this exemplary embodiment is almost identical with the printer in the first exemplary embodiment, except that an operation to be performed when an incompatibility is found can be described in an instruction book to thereby perform the operation for the incompatibility in accordance with the description in the instruction book. The following describes the printer in this exemplary embodiment. Portions of the description similar to that of the first exemplary embodiment are omitted or simplified.

In this exemplary embodiment, it is possible to describe in an instruction book a process (non-executable-time process) to be performed when a print instruction described in the instruction book cannot be executed on the printer.

If it is determined that a print instruction described in the instruction book cannot be executed on the printer, the printer executes a non-executable-time process described in the instruction book.

Non-executable-time processes are first to sixth processes given below. The non-executable-time processes are not limited to those processes. Two or more processes may be combined.

(First Process)

The printer sends an instruction book including incompatibility-corrected print instructions to a predetermined destination location as in the first exemplary embodiment described above. For example, the printer sends the contents of incompatibility and the instruction book including incompatibility-corrected print instructions to the mail address specified upon issuance of the print request.

(Second Process)

The printer saves an instruction book including incompatibility-corrected print instructions in a predetermined storage location as in the first exemplary embodiment described above. For example, the printer saves the instruction book including incompatibility-corrected print instructions in a storage location specified upon issuance of the print request and, at the same time, sends the information about it to the user.

(Third Process)

The printer prints the contents of incompatibility (for example, a notification indicating that the printer does not have a double-sided printing unit). Unlike a usual error notification, this process gives the user more detailed information about the contents of incompatibility.

(Fourth Process)

The printer presents the user with options for solving the incompatibility. The options presented in this process are hardware options such as a double-sided printing unit, and software options such as a document-processing application. The information on the options is sent via e-mail or displayed on the operation panel.

(Fifth Process)

The printer stops print processing.

(Sixth Process)

The printer executes print processing. In this process, the print settings to be used when an incompatibility is found may be determined in advance or described in the instruction book.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. A printer comprising:
a print request acceptance unit that accepts a print request that includes an instruction book in which print instructions are described;
an instruction book determination unit that determines if the print instructions described in the accepted instruction book can be executed on the printer;
an instruction book correction unit that, when it is determined that the print instructions described in the instruction book cannot be executed, corrects the instruction book and generates an instruction book in which print instructions executable by the printer are described; and
an instruction book output unit that outputs the generated instruction book.

2. The printer according to claim 1, wherein
the instruction book output unit sends the generated instruction book to a predetermined transmission location.

3. The printer according to claim 1, wherein
the instruction book output unit saves the generated instruction book in a predetermined storage location.

4. The printer according to claim 1, wherein
the instruction book can include a non-executable-time process, and
when it is determined that the print instructions described in the instruction book cannot be executed, the printer executes the non-executable-time process described in the instruction book.

5. A method of processing an instruction book comprising:
accepting a print request that includes an instruction book in which print instructions are described;
determining if the print instructions described in the accepted instruction book can be executed on a printer;
when it is determined that the print instructions described in the instruction book cannot be executed, correcting the instruction book and generating an instruction book in which print instructions executable by the printer are described; and
outputting the generated instruction book.

6. The method according to claim 5, wherein
the generated instruction book is sent to a predetermined transmission location.

7. The method according to claim 5, wherein
the generated instruction book is saved in a predetermined storage location.

8. The method according to claim 5, wherein
the instruction book can include a non-executable-time process, and
the method further comprising, when it is determined that the print instructions described in the instruction book cannot be executed, executing the non-executable-time process described in the instruction book.

9. A computer readable medium storing a program causing a computer to execute a process for processing an instruction book, the process comprising:
accepting a print request that includes an instruction book in which print instructions are described;
determining if the print instructions described in the accepted instruction book can be executed on a printer;
when it is determined that the print instructions described in the instruction book cannot be executed, correcting the instruction book and generating an instruction book in which print instructions executable by the printer are described; and
outputting the generated instruction book.

10. The computer readable medium according to claim 9, wherein
the generated instruction book is sent to a predetermined transmission location.

11. The computer readable medium according to claim 9, wherein
the generated instruction book is saved in a predetermined storage location.

12. The computer readable medium according to claim 9, wherein
the instruction book can include a non-executable-time process, and
the process further comprising, when it is determined that the print instructions described in the instruction book cannot be executed, executing the non-executable-time process described in the instruction book.

13. A computer data signal embodied in a carrier wave for enabling a computer to perform a process for processing an instruction book, the process comprising:
accepting a print request that includes an instruction book in which print instructions are described;
determining if the print instructions described in the accepted instruction book can be executed on a printer;
when it is determined that the print instructions described in the instruction book cannot be executed, correcting the instruction book and generating an instruction book in which print instructions executable by the printer are described; and
outputting the generated instruction book.

14. The computer data signal according to claim 13, wherein
the generated instruction book is sent to a predetermined transmission location.

15. The computer data signal according to claim 13, wherein
the generated instruction book is saved in a predetermined storage location.

16. The computer data signal according to claim 13, wherein
the instruction book can include a non-executable-time process, and
the process further comprising, when it is determined that the print instructions described in the instruction book cannot be executed, executing the non-executable-time process described in the instruction book.
